(19) United States
(12) Patent Application Publication
(10) Pub. No.: US 2025/0184053 A1
(43) Pub. Date: Jun. 5, 2025

(54) METHOD AND APPARATUS FOR COVERAGE ENHANCEMENT OF SIDELINK SYNCHRONIZATION SIGNAL BLOCK

(71) Applicant: APPLE INC., Cupertino, CA (US)

(72) Inventors: Haitong Sun, Cupertino, CA (US); Dawei Zhang, Saratoga, CA (US); Zhibin Wu, Los Altos, CA (US); Hong He, San Jose, CA (US); Wei Zeng, Saratoga, CA (US); Yushu Zhang, Beijing (CN); Chunxuan Ye, San Diego, CA (US)

(21) Appl. No.: 18/842,915

(22) PCT Filed: Feb. 23, 2023
(86) PCT No.: PCT/US2023/063107

§ 371 Date: Aug. 30, 2024

Related U.S. Application Data
(60) Provisional application No. 63/268,865, filed on Mar. 4, 2022.

(51) Int. Cl. H04L 5/00; H04W 56/00; H04W 92/18

(52) U.S. Cl. CPC H04L 5/0012; H04L 5/0048; H04W 56/0015; H04W 92/18

(57) ABSTRACT

Systems and methods for coverage enhancements for sidelink (SL) synchronization signal block (SSB) (S-SSB) between a transmit (Tx) user equipment (UE) and a receive (Rx) UE are disclosed herein. S-SSB frequency domain enhancement may use frequency hopping for S-SSB and/or S-SSB that use an increased number of physical radio bearers (PRBs). S-SSB time domain enhancements may modify an S-SSB periodicity, a number of S-SSB per period, use a clear channel assessment (CCA) (or listen before talk (LBT)) procedure, and/or transmit only some of a configured set of S-SSBs for an S-SSB periodicity. Multi-beam S-SSB enhancement may index S-SSBs of a configured set and send those S-SSBs using beams corresponding to the indexes. S-SSB enhancement using frequency domain masking and/or time domain masking may apply different masks to one or more S-SSBs.

### TECHNICAL FIELD

This application relates generally to wireless communication systems, including wireless communications system implementing sidelink (SL) communications.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi©).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FRi. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing a timeline of S-SSB transmission by a Tx UE, according to an embodiment.

FIG. 2 illustrates a frequency hopping pattern used for S-SSB transmission, according to an embodiment.

FIG. 3 illustrates a use of repeated S-SSBs in the frequency domain, according to an embodiment.

FIG. 4 illustrates a method of a UE for SL communications, according to an embodiment.

FIG. 5 illustrates a method of a UE for SL communications, according to an embodiment.

FIG. 6 illustrates a method for S-SSB time domain enhancement, according to an embodiment.

FIG. 7 illustrates a method for S-SSB time domain enhancement, according to an embodiment.

FIG. 8 illustrates a method for S-SSB time domain enhancement, according to an embodiment.

FIG. 9 illustrates a diagram showing a timeline of S-SSB transmission by a Tx UE when using CCA/LBT, according to an embodiment.

FIG. 10 illustrates a method for S-SSB time domain enhancement, according to an embodiment.

FIG. 11 illustrates a method for S-SSB time domain enhancement, according to an embodiment.

FIG. 12 illustrates a diagram illustrating transmission, by a Tx UE, of S-SSBs in a beamforming fashion, according to an embodiment.

FIG. 13 illustrates a method of a UE for SL communications, according to an embodiment.

FIG. 14 illustrates a diagram corresponding to a first option and a second option for performing frequency domain masking, according to an embodiment.

FIG. 15 illustrates a diagram corresponding to time domain masking, according to an embodiment.

FIG. 16 illustrates a method of a UE for SL communications, according to an embodiment.

FIG. 17 illustrates an example architecture of a wireless communication system, according to embodiments disclosed herein.

FIG. 18 illustrates a system for performing signaling between a first wireless device and a second wireless device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In embodiments herein, sidelink (SL) communications among two or more UE are discussed. The SL communications discussed herein contemplate communications that occur between the two or more UE without the use of an intermediary RAN device such as a base station. For example, the SL communications discussed herein include the case where signaling generated by a first UE is (directly) received at and used by a second UE.

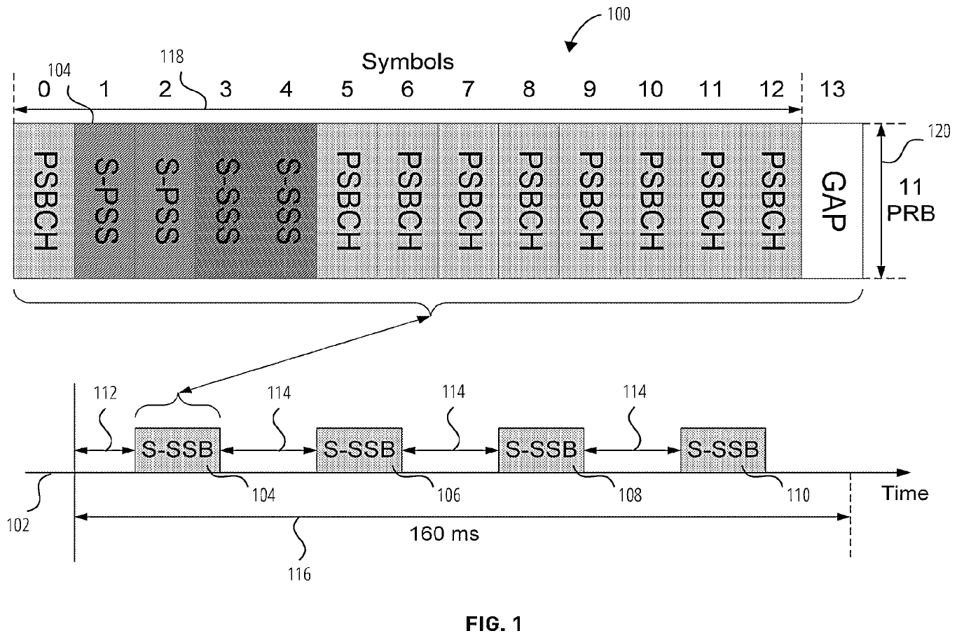

FIG. 1 illustrates a diagram 100 showing a timeline 102 of SL synchronization signal block (SSB) (S-SSB) transmission by a transmit (Tx) UE, according to an embodiment. As used herein, the term “Tx UE” may refer to a first UE that transmits one or more S-SSBs to an Rx UE. Correspondingly, as used herein, the term “receive (Rx) UE” may refer to a second UE that receives one (or more) of these one or more S-SSBs. A Tx UE and an Rx UE that communicate in this way using one or more S-SSBs may be understood to be “peer UEs” as discussed herein.

An S-SSB may be transmitted from a Tx UE to an Rx UE to enable the Rx UE to synchronize itself with the timing used by the Tx UE. As the Tx UE is presumed to have synchronized itself to some synchronization source (e.g., a base station, a global navigation satellite system (GNSS), or another UE, as will be described in additional detail herein), the Rx UE is thus enabled to be synchronized within an overall system of UEs that uses the same ultimate synchronization source at the Tx UE.

It will accordingly be understood that the Tx UE of any Tx UE to Rx UE pair under discussion may, in at least some embodiments, be itself (also) be an Rx UE that receives S-SSB(s) from its own Tx UE within the described arrangement. Further, it will be accordingly understood that the Rx UE of any Tx UE to Rx UE pair under discussion may, in at least some embodiments, be itself (also) be an Rx UE that sends S-SSB(s) to its own Rx UE within the described arrangement.

A Tx UE may transmit a plurality of S-SSBs using SL communication methods during an S-SSB periodicity 116. In some embodiments, the S-SSB periodicity 116 may be 160 milliseconds (ms), as illustrated in FIG. 1.

The diagram 100 of FIG. 8 corresponds to a timeline 102 where the Tx UE transmits four such S-SSBs (the first S-SSB 104, the second S-SSB 106, the third S-SSB 108, and the fourth S-SSB 110) during the S-SSB periodicity 116, but it should be understood that a Tx UE may transmit another number (other than four) S-SSBs in other embodiments (as will be described).

The first S-SSB of an S-SSB periodicity may be located using a configurable offset relative to the system frame boundary that corresponds to the beginning of the S-SSB periodicity. For example, FIG. 1 illustrates that the first S-SSB 104 uses a configurable offset 112 from the beginning of the S-SSB periodicity 116. Each subsequent S-SSB within that same SSB periodicity may then be spaced at a configurable interval (which may or may not be the same value as the configurable offset). For example, FIG. 1 illustrates that each of the second S-SSB 106, third S-SSB 108, and fourth S-SSB 110 within the S-SSB periodicity 116 are spaced from their preceding S-SSB by a configurable interval 114.

The total number of S-SSBs that may occur during a single S-SSB periodicity may be configurable at the Tx UE. The options for such a configured number of S-SSBs may be understood according to a subcarrier spacing (SCS) and/or frequency range (e.g., FR1, FR2) currently used for the SL communications using the S-SSBs. For example, in FRI, it may be that when a 15 kilohertz (kHz) SCS is used, the number of S-SSB transmissions during a single S-SSB periodicity may be configured to be one; when a 30 kHz SCS is used, the number of S-SSB transmissions during a single S-SSB periodicity may be configured to be one or two; and when a 60 kHz SCS is used, the number of S-SSB transmissions during a single S-SSB periodicity may be configured to be one, two, or four. Further, in FR2, it may be that when a 60 kHz SCS is used, the number of S-SSB transmissions during a single S-SSB periodicity may be configured to be one, two, four, eight, 16, or 32; and when a 120 kHz SCS is used, the number of S-SSB transmissions during a single S-SSB periodicity may be configured to be one, two, four, eight, 16, 32, or 64.

As used herein, a “configured set of S-SSBs” (sometimes also referred to as a “configured S-SSB set” or similar) may represent the S-SSBs that are configured for corresponding to one S-SSB periodicity, as has just been described. Accordingly, for example, it may be understood that a configured set of S-SSBs under discussion represents 64 S-SSBs when a Tx UE has been configured for 64 S-SSBs in each S-SSB periodicity.

As illustrated in the expansion of the first S-SSB 104 that is shown in FIG. 1, an S-SSB may in some cases have a time domain 118 of 13 symbols. An example is shown in FIG. 1, where the first S-SSB 104 is illustrated using 13 symbols (symbols 0 through 12). The “GAP” illustrated in symbol 13 of the first S-SSB 104 may correspond to an intentional non-use of symbol 13 for SL by the Tx UE, according to a SL slot arrangement being used. The illustrated case may correspond to the use of normal cyclic prefix (CP) for the S-SSB transmission.

In other cases, an S-SSB may instead have a time domain of 11 symbols. This case may correspond to the use of an extended CP for the S-SSB transmission.

Further, as illustrated in FIG. 1, an S-SSB may have a frequency domain 120 of 11 physical resource blocks (PRBs).

An S-SSB may include a physical sidelink broadcast channel (PSBCH) that is used to communicate some data (e.g., SL master information block (MIB) (SL-MIB) data) between the Tx UE transmitting the S-SSB and an Rx UE receiving the S-SSB. The expanded view of the first S-SSB 104 of FIG. 1 illustrates that the first S-SSB 104 includes a PSBCH on slots zero and slots five through 12.

An S-SSB may further includes a sidelink primary synchronization signal (S-PSS) and a sidelink secondary synchronization signal (S-SSS). The expanded view of the first S-SSB 104 of FIG. 1 illustrates that the first S-SSB 104 includes an S-PSS on slots one and two, and an S-SSS on slots three and four.

The S-PSS and the S-SSS of an S-SSB may together be used to represent a sidelink synchronization identity (SSID) of the S-SSB. In some wireless communications systems, it may be possible for an S-SSB to correspond to one of 672 different SSIDs (indexed from zero to 671). The S-PSS may indicate which half of the 672 SSIDs includes the SSID for the S-SSB (e.g., where a value of zero indicates that the S-SSB has an SSID with an index in the range of zero to 335, and where the value of 1 indicates that the S-SSB has an SSID with an index in the range of 336 to 671). The S-SSS may then include a sub-index (between 0 and 335) that indicates the particular SSID in the half identified by the S-PSS that is the SSID for the S-SSB.

An SSID may be used to represent, to a receiving Rx UE, synchronization information for the Tx UE that is transmitting the S-SSB. An SSID index of 0 may represent to the Rx UE that the S-SSB is from a Tx UE that is synchronized to GNSS (e.g., global positioning system (e.g., global positioning system (GPS), global navigation satellite system (GLONASS)) via direct signaling with the GNSS. An SSID index in the range of 1 to 335 may indicate to the Rx UE that the S-SSB is from a Tx UE that has derived its own synchronization via either direct synchronization with a base station or from another UE that itself derives its synchronization via direct synchronization with the base station. An SSID index of 336 or 337 may indicate to the Rx UE that the Tx UE is synched indirectly to GNSS (e.g., through another UE that is synced with the GNSS). An SSID index in the range of 336 to 671 may indicate to the Rx UE that the Tx UE is out-of-coverage and has derived its own synchronization from another UE that is (also) out-of-coverage.

In some circumstances, it may be beneficial to expand upon the S-SSB usage design as has been described in relation to FIG. 1.

For example, in cases where there is a need to cover large distances (e.g., two kilometers (km) or greater) with a frequency band that is less than 1 gigahertz (GHz) in the case of SL communication between handheld UEs, a maximum coupling loss requirement may be close to or more than 160 decibels (dB). Such a requirement may not be satisfied when using the S-SSB scheme of FIG. 1.

Further, in some cases, it may be that SL communications may be desired to be performed within frequency spectrum that is unlicensed by a relevant governing authority, but that has been made open by that governing authority for usage by many different wireless devices according to a pre-arranged set of rules. In such cases, the rules governing the use of this spectrum may require clear channel assessment (CCA)/listen before talk (LBT) to be implemented by wireless devices (e.g., UEs) that are to transmit within this spectrum. The requirement to use CCA/LBT may interfere with the implicit assumption of the S-SSB usage design of FIG. 1 for SSB transmission with a known periodicity. Further, the rules for the unlicensed spectrum may include spectrum density restrictions which may preclude the use of the S-SSB usage design of FIG. 1.

Accordingly, for these and other reasons, various changes and enhancements to S-SSB design and/or usage (as compared to the case described in FIG. 1) are contemplated herein in order to extend the uses of S-SSB into cases where the usage model described in relation to FIG. 1 may be insufficient or otherwise less desirable.

### Embodiments for S-SSB Frequency Domain Enhancement

It is contemplated that one or more embodiments for S-SSB frequency domain enhancement as discussed herein may be combined with other embodiments for S-SSB enhancement described herein.

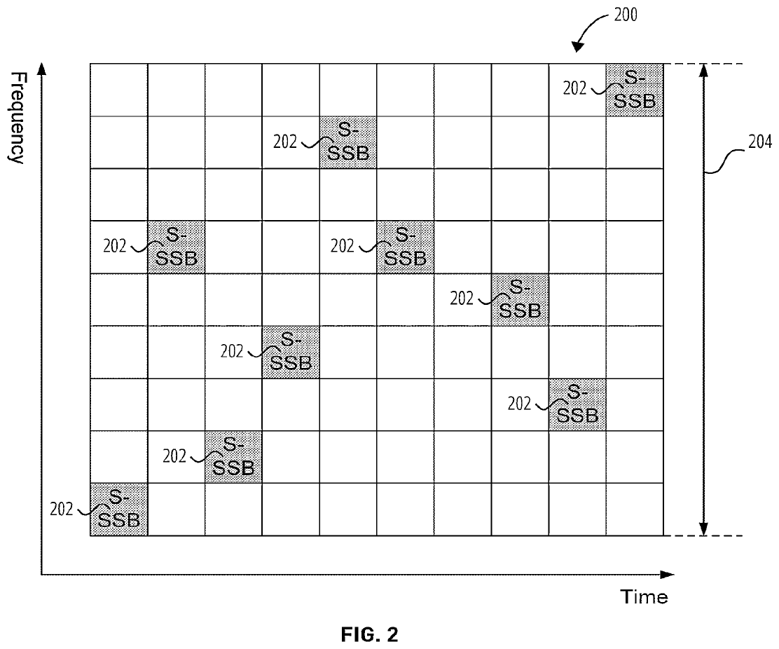

FIG. 2 illustrates a frequency hopping pattern 200 used for S-SSB transmission, according to an embodiment. As illustrated, the S-SSBs 202 being transmitted by the Tx UE may be arranged according to a frequency hopping pattern. This results in ones of the S-SSBs 202 (e.g., within the same S-SSB periodicity) being sent using a different set of PRBs (e.g., unlike the timeline 102 of FIG. 1, where each of the first S-SSB 104, the second S-SSB 106, the third S-SSB 108, and the fourth S-SSB 110 are sent using the same set of PRBs).

This frequency hopping behavior may allow for the transmission of S-SSB signaling in unlicensed bands by the Tx UE. For example, the frequency hopping behavior applied to the S-SSBs 202 may cause the overall frequency range 204 used by the S-SSBs 202 to meet a minimum frequency occupation requirement imposed by rule on the use of a frequency band of unlicensed spectrum.

Additionally, the frequency hopping behavior may allow for the use of additional SSIDs between the Tx UE and the Rx UE (e.g., beyond the 672 previously described in relation to FIG. 1). For example, a first frequency hopping pattern (e.g., as illustrated in FIG. 1) could be associated with a first set (e.g., of 672, or some other number) of SSIDs, and a second frequency hopping pattern (e.g., other than that illustrated in FIG. 1) could be associated with a second set (e.g., of 672, or some other number) of different SSIDs. Accordingly, the Tx UE could communicate to the Rx UE a grouping of SSIDs associated with the transmitted S-SSBs according to the frequency hopping pattern used, and the particular SSID (within that grouping) for one or more of the S-SSBs could then be determined by, for example, using the S-PSS and the S-SSS of each one of the S-SSBs, similarly to the manner described in relation to FIG. 1.

The frequency hopping behavior may also be used as a mechanism for SL UE-to-UE pair differentiation. For example, a first pair of UE (e.g., using the same SL resource pool) may use a first frequency hopping pattern (e.g., the frequency hopping pattern 200) for S-SSB transmission, and a second pair of UE may use a second frequency hopping pattern (e.g., a frequency hopping pattern other than the frequency hopping pattern 200) for S-SSB transmission. In this way, the first and second pairs of UE may experience reduced interference in the case that a same frequency range 204 (or overlapping frequency ranges) are used for the respective S-SSB transmission behavior.

The frequency hopping behavior may also allow each individual S-SSB to be transmitted with a higher power (as opposed to the case illustrated in FIG. 1) without breaking a maximum power spectrum density (PSD) use requirement, as the higher power used for each S-SSB is ameliorated via the extended frequency range 204 (e.g., as opposed to the case of FIG. 1, where each S-SSB is sent using the same 11 PRBs).

In some embodiments, S-SSB frequency domain use enhancement may be performed by increasing a number of PRB that can be occupied by individual S-SSB(s) (e.g., over the case of FIG. 1, where the S-SSBs occupy 11 PRBs). This may be done by increasing the sequence length (e.g., m-sequence length) of the S-SSS and/or the S-PSS of the S-SSB(s) (e.g., to a larger prime number). In some embodiments, a sequence length of 257 may be used such that an individual S-SSB uses 24 PRBs. In some embodiments, a sequence length of 383 may be used such that an individual S-SSB uses 36 PRBs. In some embodiments, a sequence length of 509 may be used such that an individual S-SSB uses 48 PRBs. In some embodiments, a sequence length of 773 may be used such that an individual S-SSB uses 72 PRBs. In some embodiments, a sequence length of 1033 may be used such that an individual S-SSB uses 96 PRBs. Other possible sequence length/PRB size arrangements are contemplated.

This S-SSB frequency occupation expansion may allow for the use of the S-SSB signaling in unlicensed bands by the Tx UE. For example, the S-SSB frequency occupation expansion behavior as applied to the S-SSBs may cause the overall frequency range used by the S-SSBs to meet a minimum frequency occupation requirement imposed by rule on the use of a frequency band of unlicensed spectrum.

This S-SSB frequency occupation expansion may also allow each individual S-SSB to be transmitted with a higher power (as opposed to the case illustrated in FIG. 1) without breaking a maximum PSD use requirement, as the higher power used for each S-SSB is ameliorated via the extended frequency range used by each S-SSB (e.g., as opposed to the case of FIG. 1, where each S-SSB is sent using 11 PRBs).

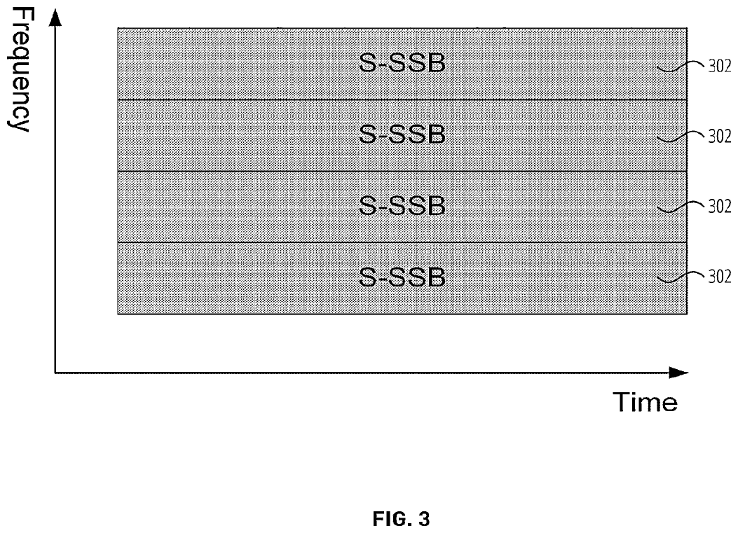

FIG. 3 illustrates a use of repeated S-SSBs 302 in the frequency domain, according to an embodiment. An S-SSB (e.g., structured as described in relation to FIG. 1) may be repeated in the frequency domain, as illustrated.

This S-SSB repetition may allow for the use of the S-SSB signaling in unlicensed bands by the Tx UE. For example, the S-SSB repetition may cause the overall frequency range used by the repeated S-SSBs 302 to meet a minimum frequency occupation requirement imposed by rule on the use of a frequency band of unlicensed spectrum.

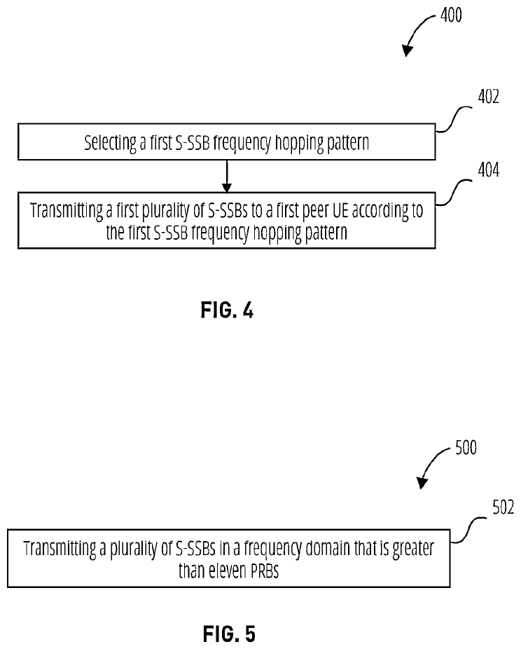

FIG. 4 illustrates a method 400 of a UE for SL communications, according to an embodiment. The method 400 includes selecting 402 a first S-SSB frequency hopping pattern.

The method 400 further includes transmitting 404 a first plurality of S-SSBs to a first peer UE according to the first S-SSB frequency hopping pattern.

In some embodiments of the method 400, SSIDs used by the first plurality of S-SSBs correspond to the first frequency hopping pattern.

In some embodiments, the method 400 further includes selecting a second S-SSB frequency hopping pattern, and transmitting a second plurality of S-SSBs to a second peer UE according to the second frequency hopping pattern. In some of these embodiments, first synchronization signal identifiers (SSIDs) used by the first plurality of S-SSBs correspond to the first frequency hopping pattern, and second SSIDs used by the second plurality of S-SSBs correspond to the second frequency hopping pattern.

In some embodiments of the method 400, the SL communications use a subcarrier spacing that is between 15 kilohertz (kHz) and 60 kHz, inclusive, and the SL communications comprise transmitting 64 or more configured S-SSBs within one period of an S-SSB periodicity.

In some embodiments of the method 400, the SL communications use a subcarrier spacing that is between 15 kilohertz (kHz) and 120 kHz, inclusive, and the SL communications comprise transmitting 128 or more configured S-SSBs within one period of an S-SSB periodicity.

In some embodiments, the method 400 further includes performing a CCA on a carrier to be used by the UE for an S-SSB transmission and performing the S-SSB transmission after a completion of the CCA. In some of these embodiments, the method 1600 further includes including an indication of an amount of transmission delay imposed on the S-SSB transmission due to the CCA relative to a configured transmission timing for the S-SSB transmission.

In some embodiments, the method 400 further includes identifying, to the peer UE, one or more configured S-SSBs of a configured set of S-SSBs. In some of these embodiments, the one or more configured S-SSBs are identified to the peer UE using a bitmap, wherein bits of the bitmap each correspond to one of the configured set of S-SSBs. In some of these embodiments, the one or more configured S-SSBs are identified to the peer UE using a first bitmap and a second bitmap, wherein the first bitmap identifies segments of the configured set of S-SSBs that include one or more of the configured S-SSBs and the second bitmap identifies the one or more of the configured S-SSBs within each segment.

FIG. 5 illustrates a method 500 of a UE for SL communications, according to an embodiment. The method 500 includes transmitting 502 a plurality of S-SSBs in a frequency domain that is greater than eleven PRBs.

In some embodiments of the method 500, each of the plurality of S-SSBs comprise more than 11 PRBs.

In some embodiments of the method 500, the plurality of S-SSBs comprises repeated S-SSBs in the frequency domain.

In some embodiments of the method 500, the SL communications use a subcarrier spacing that is between 15 kHz and 60 kHz, inclusive, and the SL communications comprise transmitting 64 or more configured S-SSBs within one period of an S-SSB periodicity.

In some embodiments of the method 500, the SL communications use a subcarrier spacing that is between 15 kHz and 120 kHz, inclusive, and the SL communications comprise transmitting 128 or more configured S-SSBs within one period of an S-SSB periodicity.

In some embodiments, the method 500 further includes performing a CCA on a carrier to be used by the UE for an S-SSB transmission and performing the S-SSB transmission after a completion of the CCA. In some of these embodiments, the method 1600 further includes including an indication of an amount of transmission delay imposed on the S-SSB transmission due to the CCA relative to a configured transmission timing for the S-SSB transmission.

In some embodiments, the method 500 further includes identifying, to the peer UE, one or more configured S-SSBs of a configured set of S-SSBs. In some of these embodiments, the one or more configured S-SSBs are identified to the peer UE using a bitmap, wherein bits of the bitmap each correspond to one of the configured set of S-SSBs. In some of these embodiments, the one or more configured S-SSBs are identified to the peer UE using a first bitmap and a second bitmap, wherein the first bitmap identifies segments of the configured set of S-SSBs that include one or more of the configured S-SSBs and the second bitmap identifies the one or more of the configured S-SSBs within each segment.

Embodiments contemplated herein include an apparatus comprising means to perform one or more elements of the method 400 or the method 500. This apparatus may be, for example, an apparatus of a UE (such as one of the first wireless device 1802 or the second wireless device 1818 that is a UE, as described herein).

Embodiments contemplated herein include one or more non-transitory computer-readable media comprising instructions to cause an electronic device, upon execution of the instructions by one or more processors of the electronic device, to perform one or more elements of the method 400 or the method 500. This non-transitory computer-readable media may be, for example, a memory of a UE (such as a memory 1806 or memory 1822 of one of the first wireless device 1802 or the second wireless device 1818 that is a UE, as described herein).

Embodiments contemplated herein include an apparatus comprising logic, modules, or circuitry to perform one or more elements of the method 400 or the method 500. This apparatus may be, for example, an apparatus of a UE (such as one of the first wireless device 1802 or the second wireless device 1818 that is a UE, as described herein).

Embodiments contemplated herein include an apparatus comprising: one or more processors and one or more computer-readable media comprising instructions that, when executed by the one or more processors, cause the one or more processors to perform one or more elements of the method 400 or the method 500. This apparatus may be, for example, an apparatus of a UE (such as one of the first wireless device 1802 or the second wireless device 1818 that is a UE, as described herein).

Embodiments contemplated herein include a signal as described in or related to one or more elements of the method 400 or the method 500

Embodiments contemplated herein include a computer program or computer program product comprising instructions, wherein execution of the program by a processor is to cause the processor to carry out one or more elements of the method 400 or the method 500. The processor may be a processor of a UE (such as processor(s) 1804 or processor(s) 1820 of one of the first wireless device 1802 or the second wireless device 1818 that is a UE, as described herein). These instructions may be, for example, located in the processor and/or on a memory of the UE (such as a memory 1806 or memory 1822 of one of the first wireless device 1802 or the second wireless device 1818 that is a UE, as described herein).

### Embodiments for S-SSB Time Domain Enhancement

It is contemplated that one or more embodiments for S-SSB time domain enhancement as discussed herein may be combined with other embodiments for S-SSB enhancement described herein.

In some cases of S-SSB time domain enhancement, the S-SSB periodicity that is used may be relatively smaller (e.g., as compared to the 160 ms case illustrated in relation to FIG. 1). For example, the S-SSB periodicity used may be one of 5 ms, 10 ms, 20 ms, 40 ms, 80 ms, or some other value less than 160 ms. This value may be configured (e.g., at the Tx UE by the base station) using an “SL-SyncConfig” information element (IE).

The relative reduction in the S-SSB periodicity causes the corresponding configured set of S-SSBs to be transmitted relatively more frequently. Accordingly, an Rx UE has additional opportunities to receive the one or more S-SSBs of an S-SSB configured set used in periods of those (smaller) periodicities as opposed to the case of a relatively longer S-SSB periodicity. This may enable the Rx UE to, for example, synchronize to the Tx UE faster than it might otherwise have, and/or to confirm and/or correct its synchronization with the Tx UE more frequently (increasing overall synchronization accuracy).

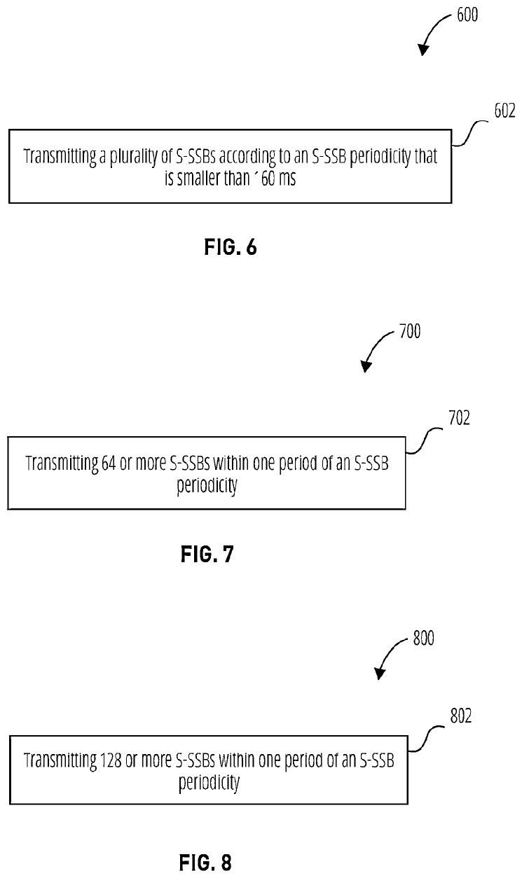

FIG. 6 illustrates a method 600 for S-SSB time domain enhancement, according to an embodiment. The method 600 includes transmitting 602 a plurality of S-SSBs according to an S-SSB periodicity that is smaller than 160 milliseconds.

In some embodiments of the method 600, the S-SSB periodicity used may be one of 5 ms, 10 ms, 20 ms, 40 ms, 80 ms, or some other value less than 160 ms.

In some embodiments of the method 600, the S-SSB periodicity may be configured using an additional information element in an “SL-SyncConfig” IE.

In some cases of S-SSB time domain enhancement, regardless of frequency range (e.g., FR1, FR2, etc.) and/or SCS used, a Tx UE may be configured to transmit up to 64, 128, or 256 (or some other number, e.g., more than 256) configured S-SSBs during a single S-SSB periodicity.

The use of a relatively higher number of S-SSBs in a set of configured S-SSBs in this fashion may be useful in the case where beamformings are applied to the S-SSBs (such as in, for example, embodiments discussed herein). For example, a relatively higher number of S-SSBs in the configured set of S-SSBs in cases where beamformings are used on the S-SSBs may allow for narrower beams to be used by the Tx UE while still having desired coverage density relative to the entire spatial channel, thereby improving the performance of subsequent beamformed transmissions by the Tx UE that use one of these (relatively narrower) beams (e.g., as determined using a beam sweep using the S-SSB beamformings).

FIG. 7 illustrates a method 700 for S-SSB time domain enhancement, according to an embodiment. The method 700 includes transmitting 702 64 or more S-SSBs within one period of an S-SSB periodicity. For example, it may be that SL communications between the Tx UE and the Rx UE may use an SCS that is between 15 kHz and 60 kHz, inclusive, and the Tx UE may transmit 64 or more configured S-SSBs within one period of an S-SSB periodicity.

FIG. 8 illustrates a method 800 for S-SSB time domain enhancement, according to an embodiment. The method 800 includes transmitting 802 128 or more S-SSBs within one period of an S-SSB periodicity. For example, it may be that SL communications between the Tx UE and the Rx UE use an SCS that is between 15 kHz and 120 kHz, inclusive, and the Tx UE may transmit 128 or more configured S-SSBs within one period of an S-SSB periodicity.

In some cases of S-SSB time domain enhancement, when using unlicensed spectrum, an actual S-SSB transmission can be delayed (compared to the time of an otherwise expected S-SSB transmission) due to the use of a CCA/LBT procedure required by rule to be used in the unlicensed spectrum prior to transmission.

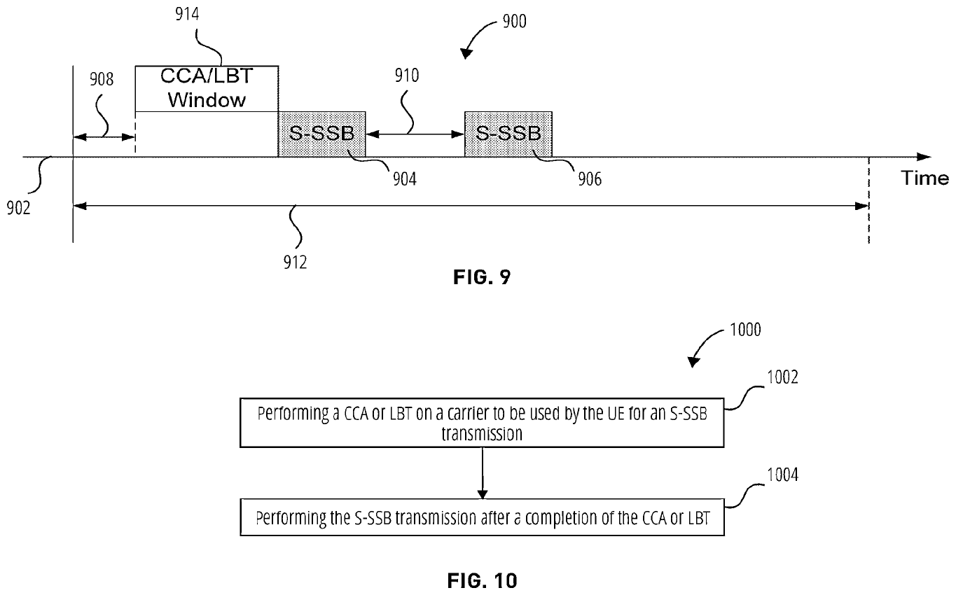

FIG. 9 illustrates a diagram 900 showing a timeline 902 of S-SSB transmission by a Tx UE when using CCA/LBT, according to an embodiment. The Tx UE is configured to transmit a pair of S-SSBs, the first S-SSB 904 and the second S-SSB 906.

A configurable offset 908 may be applied relative to the system frame boundary corresponding to the S-SSB periodicity 912 much like as was described in relation to FIG. 1. Further, the first S-SSB 904 and the second S-SSB 906 may be separated by a configurable interval 910, as has been described.

However, differently from FIG. 1, the Tx UE is illustrated to perform a CCA/LBT on the carrier it intends to use in the CCA/LBT window 914 prior to the transmission of the first S-SSB 904 and second S-SSB 906. This may comply with a rule for using a frequency range in the unlicensed spectrum that requires by rule a check on the current usage of the carrier/channel to be used prior to a transmission. As can be seen, the use of the CCA/LBT window 914 may delay the transmission of the first S-SSB 904 and the second S-SSB 906 as compared to a case that does not use the CCA/LBT window 914 (for example, the case illustrated in FIG. 1).

The size of the CCA/LBT window 914 may vary across instances according to the timeline 902, as the CCA/LBT process completes when the carrier/channel is determined by the CCA/LBT process to be clear, and this circumstance may vary with the variable use of the channel by other wireless devices. Accordingly, an expected transmission position in time for sending the first of the S-SSBs (e.g., the first S-SSB 904) relative to beginning of the relevant period of the S-SSB periodicity 912 cannot be known ahead of time at either the Tx UE or the Rx UE. Accordingly, once the CCA/LBT process completes, prior to sending the S-SSBs, the Tx UE may encode in the MIB of the PSBCHs of one or more of the S-SSBs (e.g., in the first S-SSB 904 and/or the second S-SSB 906) with the amount of delay that was imposed on the S-SSBs due to the use of the CCA/LBT window 914. Accordingly, when the Tx UE receives an S-SSBs having this information, the Tx UE is accordingly enabled to account for the delay imposed on the received S-SSB(s) by the CCA/LBT window 914 when using the received S-SSB(s) to synchronize with the Tx UE.

FIG. 10 illustrates a method 1000 for S-SSB time domain enhancement, according to an embodiment. The method 1000 includes performing 1002 a CCA or LBT on a carrier to be used by the UE for an S-SSB transmission.

The method 1000 further includes performing 1004 the S-SSB transmission after a completion of the CCA or LBT.

In some embodiments, the method 1000 further includes including, in the S-SSB transmission, an indication of an amount of transmission delay imposed on the S-SSB transmission due to the CCA or LBT relative to a configured transmission timing for the S-SSB transmission.

In some cases of S-SSB time domain enhancement, it may be that only some of the S-SSBs of a configured set of S-SSBs may be actually sent (e.g., in each of one or more periods of the relevant S-SSB periodicity). This may be done to match the time division duplexing (TDD) configuration or the duplexing direction configuration used between a Tx UE and an Rx UE. This may also act to reduce the processing burden on the Rx UE for hypothesis testing. The transmission of less than the full configured set of S-SSBs during an S-SSB periodicity may also act to account for any effective reduction of the usable period during the S-SSB periodicity for transmission of S-SSBs due to CCA/LBT window use, as has been described herein.

The pattern of actually transmitted S-SSBs relative to the configured set of S-SSBs can be configured between the Tx UE and the Rx UE. Stated otherwise, the Tx UE may inform an Rx UE of the actually transmitted S-SSBs relative to the configured set of S-SSBs.

In a first case, a full bitmap may be used to represent the actually transmitted S-SSBs of the configured set of S-SSBs. For example, in the case where the configured set of S-SSBs has 64 S-SSBs, it may be that a 64 bit bitmap is used. In some cases, “1” in the i-th location in the bitmap represents that the i-th S-SSB of the configured set is to be transmitted, while a “0” in an i-th location in the bitmap represents that the i-th S-SSB of the configured set is not to be transmitted.

In a second case, two bitmaps may be used to represent the actually transmitted S-SSBs of the configured set of S-SSBs. For example, in the case where the configured set of S-SSBs has 64 S-SSBs, it may be that a bitmap of dimension N and a bitmap of dimension M are used, where N*M=64. In such a case, the total number (e.g., 64) of S-SSBs may be divided into M segments, with each segment having N S-SSBs. Then, a “1” in the i-th bit of the bitmap M represents that the i-th segment (of the M segments) has one or more S-SSBs that are to actually be transmitted. Further, a “1” in the i-th bit of the bitmap N represents that the i-th individual S-SSB within each previously indicated segment in the bitmap M is to be transmitted.

As will be understood with reference the above description, the second case may ultimately use fewer total bits (N+M bits) as opposed to the first case (using a full 1:1 bitmap for the full set of configured S-SSB). For example, take again the case of a configured set of S-SSBs including 64 S-SSBs. The first case may use a 64 bit bitmap to represent all 64 S-SSBs on a 1:1 basis. The second case may instead take N=8 and M=8 (with 8*8=64), with the bitmaps N and M taken together only requiring 8+8=16 bits.

In whichever case, the bitmap(s), once generated, may be signaled from the Tx UE to the Rx UE. This may occur after the Tx UE and the Rx UE have an initial communication path (either via SL, and/or via a RAN in the case of pre-configuration or configuration of the SL transmission aspects by a base station). Accordingly, the bitmap(s) may be transmitted in various cases in RRC messages, in system information messages, in a medium access control elements (MAC CEs), uplink signaling, downlink control information (DCI), and/or sidelink control information (SCI).

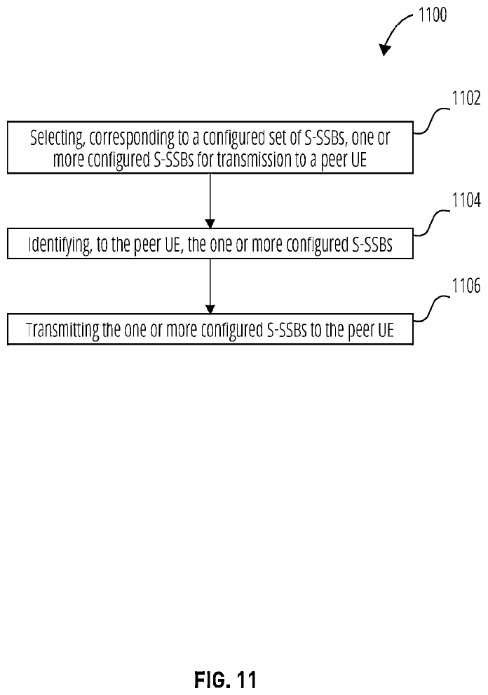

FIG. 11 illustrates a method 1100 for S-SSB time domain enhancement, according to an embodiment. The method 1100 includes selecting 1102, corresponding to a configured set of S-SSBs, one or more configured S-SSBs for transmission to a peer UE.

The method 1100 further includes identifying 1104, to the peer UE, the one or more configured S-SSBs.

The method 1100 further includes transmitting 1106 the one or more configured S-SSBs to the peer UE.

In some embodiments of the method 1100, the one or more configured S-SSBs are identified to the peer UE using a bitmap, wherein bits of the bitmap each correspond to one of the configured set of S-SSBs.

In some embodiments of the method 1100, the first bitmap identifies segments of the configured set of S-SSBs that include one or more of the configured S-SSBs, and the second bitmap identifies the one or more of the configured S-SSBs within each segment.

Embodiments contemplated herein include an apparatus comprising means to perform one or more elements of the method 600, the method 700, the method 800, the method 1000, or the method 1100. This apparatus may be, for example, an apparatus of a UE (such as one of the first wireless device 1802 or the second wireless device 1818 that is a UE, as described herein).

Embodiments contemplated herein include one or more non-transitory computer-readable media comprising instructions to cause an electronic device, upon execution of the instructions by one or more processors of the electronic device, to perform one or more elements of the method 600, the method 700, the method 800, the method 1000, or the method 1100. This non-transitory computer-readable media may be, for example, a memory of a UE (such as a memory 1806 or memory 1822 of one of the first wireless device 1802 or the second wireless device 1818 that is a UE, as described herein).

Embodiments contemplated herein include an apparatus comprising logic, modules, or circuitry to perform one or more elements of the method 600, the method 700, the method 800, the method 1000, or the method 1100. This apparatus may be, for example, an apparatus of a UE (such as one of the first wireless device 1802 or the second wireless device 1818 that is a UE, as described herein).

Embodiments contemplated herein include an apparatus comprising: one or more processors and one or more computer-readable media comprising instructions that, when executed by the one or more processors, cause the one or more processors to perform one or more elements of the method 600, the method 700, the method 800, the method 1000, or the method 1100. This apparatus may be, for example, an apparatus of a UE (such as one of the first wireless device 1802 or the second wireless device 1818 that is a UE, as described herein).

Embodiments contemplated herein include a signal as described in or related to one or more elements of the method 600, the method 700, the method 800, the method 1000, or the method 1100.

Embodiments contemplated herein include a computer program or computer program product comprising instructions, wherein execution of the program by a processor is to cause the processor to carry out one or more elements of the method 600, the method 700, the method 800, the method 1000, or the method 1100. The processor may be a processor of a UE (such as processor(s) 1804 or processor(s) 1820 of one of the first wireless device 1802 or the second wireless device 1818 that is a UE, as described herein). These instructions may be, for example, located in the processor and/or on a memory of the UE (such as a memory 1806 or memory 1822 of one of the first wireless device 1802 or the second wireless device 1818 that is a UE, as described herein).

### Embodiments of Multi-Beam S-SSB Enhancement

It is contemplated that one or more embodiments for multi-beam S-SSB enhancement as discussed herein may be combined with other embodiments for S-SSB enhancement described herein.

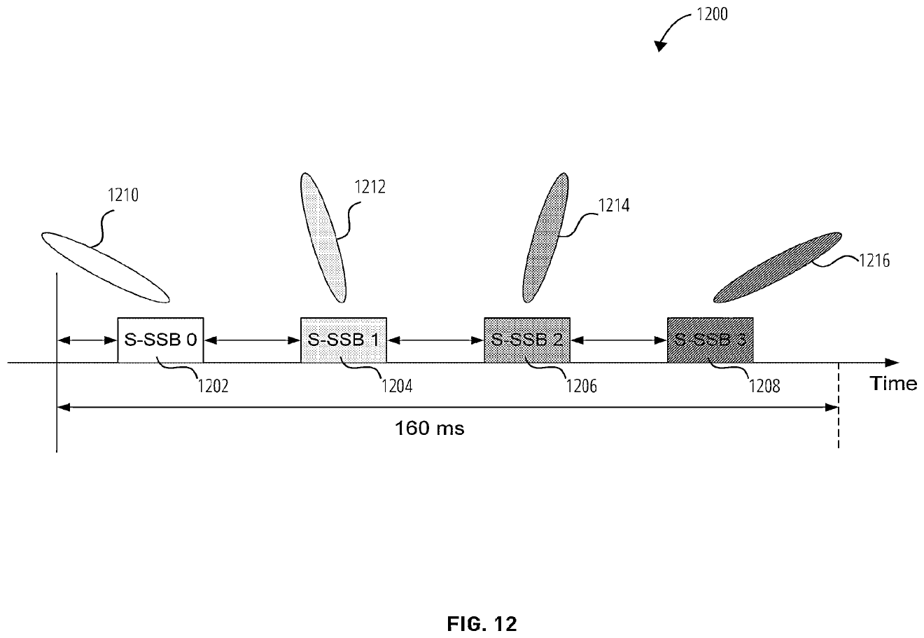

FIG. 12 illustrates a diagram 1200 illustrating transmission, by a Tx UE, of S-SSBs in a beamforming fashion, according to an embodiment. The network (e.g., via a base station) may dynamically signal or configure or pre-configure the Tx UE with indexes corresponding to a configured set of S-SSBs. In the example of FIG. 12, the first S-SSB 1202 has been assigned index 0, the second S-SSB 1204 has been assigned index 1, the third S-SSB 1206, has been assigned index 2, and the fourth S-SSB 1208 has been assigned index 3.

The Tx UE may understand the different indexes for the S-SSBs to correspond to different beamformings on which the S-SSBs are to be sent. For example, the first S-SSB 1202 is sent using the first beamforming 1210 (corresponding to index 0), the second S-SSB 1204 is sent using the second beamforming 1212 (corresponding to index 1), the third S-SSB 1206 is sent using the third beamforming 1214 (corresponding to index 2) and the fourth S-SSB 1208 is sent using the fourth beamforming 1216 (corresponding to the index 3).

Note that while not illustrated here, it is contemplated that different S-SSBs within a configured set of S-SSBs may be assigned the same index (and thus use the same beamforming).

The S-SSBs may indicate to an Rx UE the indexes with which they have been assigned. In a first case, an S-SSB may implicitly indicate its index to the Rx UE based on the transmission timing of the S-SSB. This type of indication may be used in cases where the Rx UE receives all of the S-SSBs of the configured set.

In a second case, an S-SSB may indicate its index in its PSBCH payload (e.g., in an MIB of its PSBCH payload).

In a third case, an S-SSB may indicate a first portion of its index using its PSFCH payload. For example, a most significant bit (MSB) or a least significant bit (LSB) of a value representing its index may be included in its PSFCH payload. The S-SSB may further indicate a second portion of its index using PSBCH payload scrambling, cyclic redundancy check (CRC) scrambling, and/or PSBCH demodulation reference signal (DMRS) generation (e.g., where the particular nature of the PSBCH payload scrambling, particular nature of CRC scrambling, and/or the location of a PSBCH DMRS used by that S-SSB indicates remaining bit(s) of a value representing its index).

In a fourth case, a new symbol and/or sequence is used by an S-SSB to indicate its index.

When transmitting S-SSBs using multi-beam enhancement methods (e.g., as described herein), the Tx UE may cause that within an S-SSB, all symbols/channels (e.g., the S-PSS, the S-SSS, and the PSBCH) are transmitted with the same Doppler spread, the same Doppler shift, a same average delay, a same delay spread, and when applicable, same spatial Rx parameters. This ensures that the components of each individual S-SSB are consistent with each other on the transmission channel.

Further, within a single period of an S-SSB periodicity, the Tx UE may cause that all transmitted S-SSBs are be transmitted with a same amount of power. This ensures that a reference signal received power (RSRP) and/or signal to interference and noise ratio (SINR) of the S-SSBs measured at the Tx UE in the same S-SSB periodicity can be usefully compared at the Tx UE.

Further, the Tx UE may case that S-SSBs corresponding to the same indexes (e.g., across multiple periods of the S-SSB periodicity) are transmitted with the same Doppler spread, the same Doppler shift, a same average delay, a same delay spread, same spatial Rx parameters (when applicable), and/or a same transmission power. This ensures that changes over time to, for example, a measured RSRP/SINR of S-SSBs received on the beam corresponding to that index can be usefully analyzed by the Tx UE.

Note that by operating within these constraints as described (regarding Doppler spread, same Doppler shift, average delay, delay spread, spatial Rx parameters (when applicable), and/or transmission power levels, as described), the S-SSBs can be used by the Rx UE as one or more of reference signals for quasi-colocation (QCL) purposes (e.g., including QCL-Type A, QCL-Type B, QCL-Type C, and/or QCL-Type D), reference signals for path loss estimate purposes, reference signals for radio link monitoring (RLM) purposes, reference signal for beam failure detection (BFD) purposes, and/or reference signals for candidate beam detection (CBD) purposes.

Note that in other embodiments using multi-beam S-SSB enhancement as described herein, it is contemplated that a base station may take the place of the Tx UE as has been described (and may use SL signaling rather than Uu signaling, as has been described).

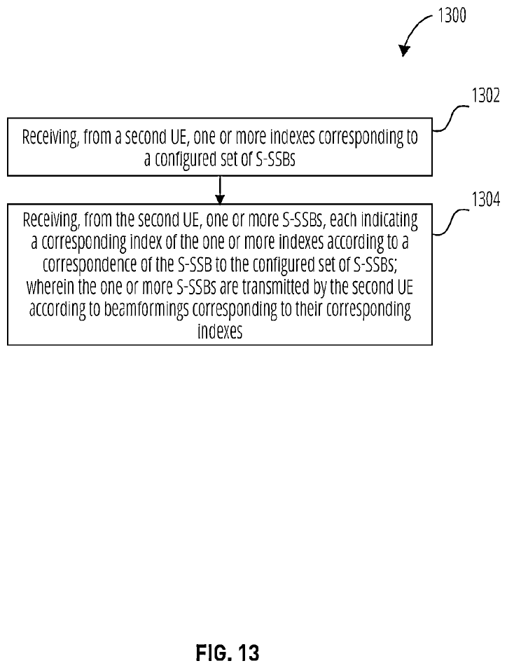

FIG. 13 illustrates a method 1300 of a UE for SL communications, according to an embodiment. The method 1300 includes receiving 1302, from a second UE, one or more indexes corresponding to a configured set of SL synchronization signal blocks (S-SSBs); and

The method 1300 further includes receiving 1304, from the second UE, one or more S-SSBs, each indicating a corresponding index of the one or more indexes according to a correspondence of the S-SSB to the configured set of S-SSBs, wherein the one or more S-SSBs are transmitted by the second UE according to beamformings corresponding to their corresponding indexes.

In some embodiments of the method 1300, the S-SSBs implicitly indicate their corresponding indexes based on their transmission timings.

In some embodiments of the method 1300, the S-SSBs indicate their corresponding indexes in PSBCH payloads.

In some embodiments of the method 1300, the S-SSBs indicate a first portion of their corresponding indexes in PSBCH payloads, and the S-SSBs indicate a second portion of their corresponding indexes using one of PSBCH scrambling, CRC scrambling, and a locations of PSBCH DMRS within the S-SSBs.

In some embodiments of the method 1300, the S-SSBs indicate their corresponding indexes using sequences found in the S-SSBs.

In some embodiments of the method 1300, each of the S-SSBs transmits each of its symbols according to one or more of a same Doppler spread, a same Doppler shift, a same average delay, a same delay spread, and a same spatial Rx parameters.

In some embodiments of the method 1300, each of the S-SSBs is transmitted with a same power.

In some embodiments of the method 1300, an S-SSB of the S-SSBs indicating a same corresponding index as a prior S-SSB of the S-SSBs is transmitted according to one or more of a same Doppler spread used to transmit the prior S-SSB, a same Doppler shift used to transmit the prior S-SSB, a same average delay used to transmit the prior S-SSB, a same delay spread used to transmit the prior S-SSB, same spatial Rx parameters used to transmit the prior S-SSB; and a same power used to transmit the prior S-SSB.

In some embodiments of the method 1300, one or more of the S-SSBs is configured to be used for one or more of a reference signal for quasi-colocation, a reference signal for a path loss estimate, a reference signal for RLM, a reference signal for BFD, and a reference signal for CBD.

In some embodiments of the method 1300, the SL communications use a subcarrier spacing that is between 15 kHz and 60 kHz, inclusive, and the SL communications comprise transmitting 64 or more configured S-SSBs within one period of an S-SSB periodicity.

In some embodiments of the method 1300, the SL communications use a subcarrier spacing that is between 15 kHz and 120 kHz, inclusive, and the SL communications comprise transmitting 128 or more configured S-SSBs within one period of an S-SSB periodicity.

In some embodiments, the method 1300 further includes performing a CCA on a carrier to be used by the UE for an S-SSB transmission and performing the S-SSB transmission after a completion of the CCA. In some of these embodiments, the method 1600 further includes including an indication of an amount of transmission delay imposed on the S-SSB transmission due to the CCA relative to a configured transmission timing for the S-SSB transmission.

In some embodiments, the method 1300 further includes identifying, to the peer UE, one or more configured S-SSBs of the configured set of S-SSBs. In some of these embodiments, the one or more configured S-SSBs are identified to the peer UE using a bitmap, wherein bits of the bitmap each correspond to one of the configured set of S-SSBs. In some of these embodiments, the one or more configured S-SSBs are identified to the peer UE using a first bitmap and a second bitmap, wherein the first bitmap identifies segments of the configured set of S-SSBs that include one or more of the configured S-SSBs and the second bitmap identifies the one or more of the configured S-SSBs within each segment.

Embodiments contemplated herein include an apparatus comprising means to perform one or more elements of the method 1300. This apparatus may be, for example, an apparatus of a UE (such as one of the first wireless device 1802 or the second wireless device 1818 that is a UE, as described herein).

Embodiments contemplated herein include one or more non-transitory computer-readable media comprising instructions to cause an electronic device, upon execution of the instructions by one or more processors of the electronic device, to perform one or more elements of the method 1300. This non-transitory computer-readable media may be, for example, a memory of a UE (such as a memory 1806 or memory 1822 of one of the first wireless device 1802 or the second wireless device 1818 that is a UE, as described herein).

Embodiments contemplated herein include an apparatus comprising logic, modules, or circuitry to perform one or more elements of the method 1300. This apparatus may be, for example, an apparatus of a UE (such as one of the first wireless device 1802 or the second wireless device 1818 that is a UE, as described herein).

Embodiments contemplated herein include an apparatus comprising: one or more processors and one or more computer-readable media comprising instructions that, when executed by the one or more processors, cause the one or more processors to perform one or more elements of the method 1300. This apparatus may be, for example, an apparatus of a UE (such as one of the first wireless device 1802 or the second wireless device 1818 that is a UE, as described herein).

Embodiments contemplated herein include a signal as described in or related to one or more elements of the method 1300.

Embodiments contemplated herein include a computer program or computer program product comprising instructions, wherein execution of the program by a processor is to cause the processor to carry out one or more elements of the method 1300. The processor may be a processor of a UE (such as processor(s) 1804 or processor(s) 1820 of one of the first wireless device 1802 or the second wireless device 1818 that is a UE, as described herein). These instructions may be, for example, located in the processor and/or on a memory of the UE (such as a memory 1806 or memory 1822 of one of the first wireless device 1802 or the second wireless device 1818 that is a UE, as described herein).

Embodiments of S-SSB Enhancement Using Frequency Domain Masking and/or Time Domain Masking

It is contemplated that one or more embodiments for S-SSB enhancement using frequency domain masking and/or time domain masking as discussed herein may be combined with other embodiments for S-SSB enhancement described herein.

Frequency domain masking may be used so that transmitted S-SSBs achieve higher frequency estimation accuracy. Frequency domain masking may be used so that transmitted S-SSBs achieve higher coverage in the cases where there is a maximum transmit spectral density regulatory requirement applicable to some or all of the bandwidth being used for S-SSB transmission.

In a first option for performing frequency domain masking, blocks of entries of an S-SSB (e.g., entries of a transmitted sequence of the S-SSB) in the frequency domain are used to transmit the S-SSB. Each block of entries comprises all entries of a transmitted sequence of an S-SSB, and each block of entries is masked by a different mask of a masking sequence. Accordingly, a number of blocks of entries may equal the number of masks of the masking sequence.

In a second option for performing frequency domain masking, one or more blocks of entries for an S-SSB in the frequency domain are used, where each block of entries comprises repetitions of one entry of a transmitted sequence of the S-SSB. Each such repetition of an entry within in a block is masked by a different element of a masking sequence. Accordingly, a number of the one or more blocks of entries may equal the number of entries in a transmitted sequence of the S-SSB.

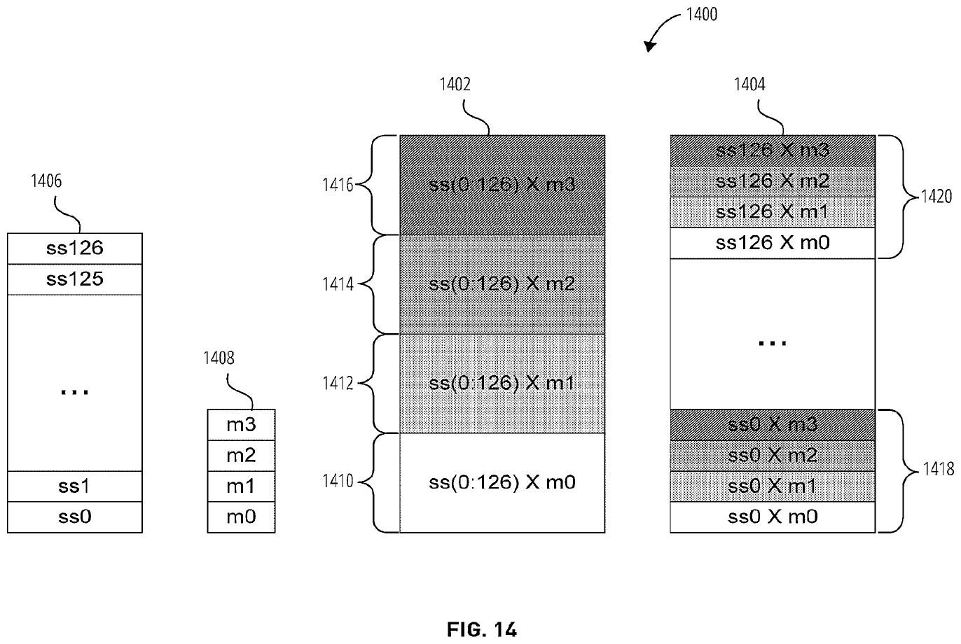

FIG. 14 illustrates a diagram 1400 corresponding to the first option 1402 and the second option 1404 for performing frequency domain masking, according to an embodiment. The diagram 1400 corresponds to the case that an S-SSB 1406 is configured to use 127 entries, (denoted from 0 to 126), and where a masking sequence 1408 includes four masks (e.g., in the form of cover codes and/or phase shift values) that are to be used to mask each entry of the S-SSB 1406, denoted m0, m1, m2, and m4.

Note that the use of 127 entries for the transmitted sequence of the S-SSB 1406 and the four masks of the masking sequence 1408 are provided by way of example and not by way of limitation. In other embodiments, an S-SSB may use fewer than or more than 127 entries in a transmitted sequence, and/or a masking sequence used may include fewer or more than 4 masks.

According to either of the first option 1402 or the second option 1404, each entry of the transmitted sequence of the S-SSB 1406 may be transmitted a total of four times in the frequency domain, which each transmission of the same entry using a different mask of the masking sequence 1408. This will now be explained in detail.

In the first option 1402, four repeated entry blocks (the first repeated entry block 1410, the second repeated entry block 1412, the third repeated entry block 1414, and the fourth repeated entry block 1416) in the frequency domain are used. Each repeated block of entries 1410, 1412, 1414, and 1416 comprises all entries of a transmitted sequence of an S-SSB (e.g., each repeated block of S-SSBs 1410, 1412, 1414, and 1416 includes all such entries for the S-SSB 1406). Finally, each repeated block of entries 1410, 1412, 1414, and 1416 is masked by a different element of the masking sequence 1408 (e.g., the entries in the first repeated entry block 1410 are each masked by m0, the entries in the second repeated entry block 1412 are each masked by m1, the entries in the third repeated entry block 1414 are each masked by m2, and the entries in the fourth repeated entry block 1416 are each masked by m3.

In the second option 1404, 127 entry blocks (e.g., the first entry block 1418 through the 127th entry block 1420, where the intermediate blocks are represented by the ellipsis in the second option 1404) in the frequency domain are used. Each block of entries comprises repetitions of one entry of a transmitted sequence of the S-SSB 1406. Further, each entry repetition of that entry (within a block) is masked by a different element of the masking sequence 1408.

Time domain repetition for S-SSBs of a configured set of S-SSBs may be used. A masking sequence used for such S-SSB repetitions may include one or more masks. Then, one or more S-SSB(s) (including up to all) of a configured set of S-SSBs may (each) be repeated over time, with each repetition of the S-SSB being masked by a different mask of the masking sequence.

In some cases, each mask may have unit energy (e.g., −1 or +1). In some cases, each mask may be a complex value with unit energy.

In some cases, each mask (e.g., of the multiple masks of the masking sequence) is the positive unit energy value. This may correspond to the case where simple repetitions of an S-SSB may be desired, without changing the physical nature of the associated transmissions as between repetitions.

In other cases, a mask sequence may be selected to have good-auto correlation in order to allow for more accurate timing acquisition by the Rx UE using the S-SSB time domain repetitions.

When using time domain repetition, the content of each S-SSB repetition (for the same S-SSB of the configured set) is the same. Further, each such S-SSB repetition is transmitted with a same Doppler spread, a same Doppler shift, a same average gain, a same average delay, a same delay spread, same spatial Rx parameters (where applicable), and/or a same transmit power.

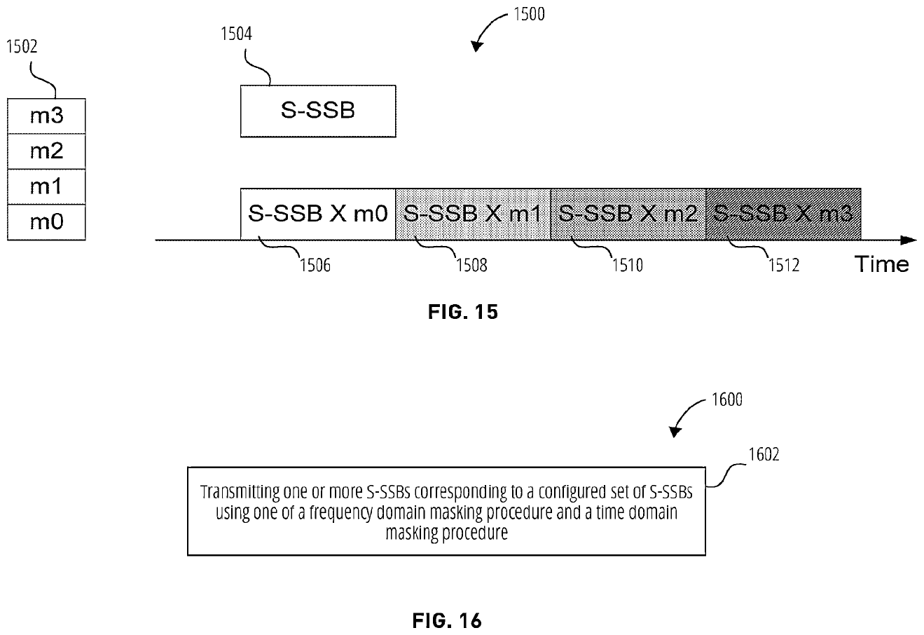

FIG. 15 illustrates a diagram 1500 corresponding to time domain masking, according to an embodiment. The example of FIG. 15 assumes a masking sequence 1502 having four masks (denoted m0, m1, m2, and m3), but other embodiments may use fewer or more masks.

The diagram 1500 further includes an S-SSB 1504. The S-SSB 1504 may correspond to one of a configured set of S-SSB 1504 that is to be transmitted. As illustrated, the actual transmission uses four repetitions of the S-SSB 1504 over time (the first S-SSB repetition 1506, the second S-SSB repetition 1508, the third S-SSB repetition 1510, and the fourth S-SSB repetition 1512). Each such repetition is masked using one of the four masked value from the masking sequence 1502 (where the first S-SSB repetition 1506 is masked by m0, the second S-SSB repetition 1508 is masked by the m1, the third S-SSB repetition 1510 is masked by m2, and the fourth S-SSB repetition 1512 is masked by m3).

It will be noted that, while not illustrated, another S-SSB corresponding to another one the configured S-SSB set (other than the S-SSB 1504) may also later be repeated four times, using each of the four masks of the masking sequence 1502.

FIG. 16 illustrates a method 1600 of a UE for SL communications, according to an embodiment. The method 1600 includes transmitting 1602 one or more S-SSBs corresponding to a configured set of S-SSBs using one of a frequency domain masking procedure and a time domain masking procedure.

In some embodiments of the method 1600, the one or more S-SSBs comprises a first S-SSB that is transmitted using the frequency domain masking procedure, wherein the first S-SSB comprises blocks of entries of a transmitted sequence of the S-SSB in the frequency domain, each block of transmitted sequence entries comprises all entries for the transmitted sequence of the S-SSB, and each block of entries is masked by a different element of a masking sequence.

In some embodiments of the method 1600, the one or more S-SSBs comprises a first S-SSB that is transmitted using the frequency domain masking procedure, wherein the first S-SSB comprises blocks of entries of a transmitted sequence of the S-SSB in the frequency domain, and each block of entries comprises repetitions of one entry of the transmitted sequence of the S-SSB, wherein each repetition is masked by a different element of a masking sequence.

In some embodiments of the method 1600, the one or more S-SSBs are transmitted using the time domain masking procedure, wherein the one or more S-SSBs comprises repetitions of an S-SSB corresponding to one of the configured set of S-SSBs in the time domain, and wherein each repetition is masked by a different element of a masking sequence. In some of these embodiments, each element of the masking sequence corresponds to a value having unit energy. In some of these embodiments, the elements of the masking sequence are identical. In some of these embodiments, the elements of the masking sequence are configured to have good auto-correlation. In some of these embodiments, each of the repetitions of the S-SSB is sent according to one or more of, a same Doppler spread; a same Doppler shift; a same average delay; a same delay spread; and a same spatial Rx parameters.

In some embodiments of the method 1600, the SL communications use a subcarrier spacing that is between 15 kHz and 60 kHz, inclusive, and the SL communications comprise transmitting 64 or more configured S-SSBs within one period of an S-SSB periodicity.

In some embodiments of the method 1600, the SL communications use a subcarrier spacing that is between 15 kHz and 120 kHz, inclusive, and the SL communications comprise transmitting 128 or more configured S-SSBs within one period of an S-SSB periodicity.

In some embodiments, the method 1600 further includes performing a CCA on a carrier to be used by the UE for an S-SSB transmission and performing the S-SSB transmission after a completion of the CCA. In some of these embodiments, the method 1600 further includes including an indication of an amount of transmission delay imposed on the S-SSB transmission due to the CCA relative to a configured transmission timing for the S-SSB transmission.

In some embodiments, the method 1600 further includes identifying, to the peer UE, one or more configured S-SSBs of the configured set of S-SSBs. In some of these embodiments, the one or more configured S-SSBs are identified to the peer UE using a bitmap, wherein bits of the bitmap each correspond to one of the configured set of S-SSBs. In some of these embodiments, the one or more configured S-SSBs are identified to the peer UE using a first bitmap and a second bitmap, wherein the first bitmap identifies segments of the configured set of S-SSBs that include one or more of the configured S-SSBs and the second bitmap identifies the one or more of the configured S-SSBs within each segment.

Embodiments contemplated herein include an apparatus comprising means to perform one or more elements of the method 1600. This apparatus may be, for example, an apparatus of a UE (such as one of the first wireless device 1802 or the second wireless device 1818 that is a UE, as described herein).

Embodiments contemplated herein include one or more non-transitory computer-readable media comprising instructions to cause an electronic device, upon execution of the instructions by one or more processors of the electronic device, to perform one or more elements of the method 1600. This non-transitory computer-readable media may be, for example, a memory of a UE (such as a memory 1806 or memory 1822 of one of the first wireless device 1802 or the second wireless device 1818 that is a UE, as described herein).

Embodiments contemplated herein include an apparatus comprising logic, modules, or circuitry to perform one or more elements of the method 1600. This apparatus may be, for example, an apparatus of a UE (such as one of the first wireless device 1802 or the second wireless device 1818 that is a UE, as described herein).

Embodiments contemplated herein include an apparatus comprising: one or more processors and one or more computer-readable media comprising instructions that, when executed by the one or more processors, cause the one or more processors to perform one or more elements of the method 1600. This apparatus may be, for example, an apparatus of a UE (such as one of the first wireless device 1802 or the second wireless device 1818 that is a UE, as described herein).

Embodiments contemplated herein include a signal as described in or related to one or more elements of the method 1600.

Embodiments contemplated herein include a computer program or computer program product comprising instructions, wherein execution of the program by a processor is to cause the processor to carry out one or more elements of the method 1600. The processor may be a processor of a UE (such as processor(s) 1804 or processor(s) 1820 of one of the first wireless device 1802 or the second wireless device 1818 that is a UE, as described herein). These instructions may be, for example, located in the processor and/or on a memory of the UE (such as a memory 1806 or memory 1822 of one of the first wireless device 1802 or the second wireless device 1818 that is a UE, as described herein).

### EXAMPLE EMBODIMENTS

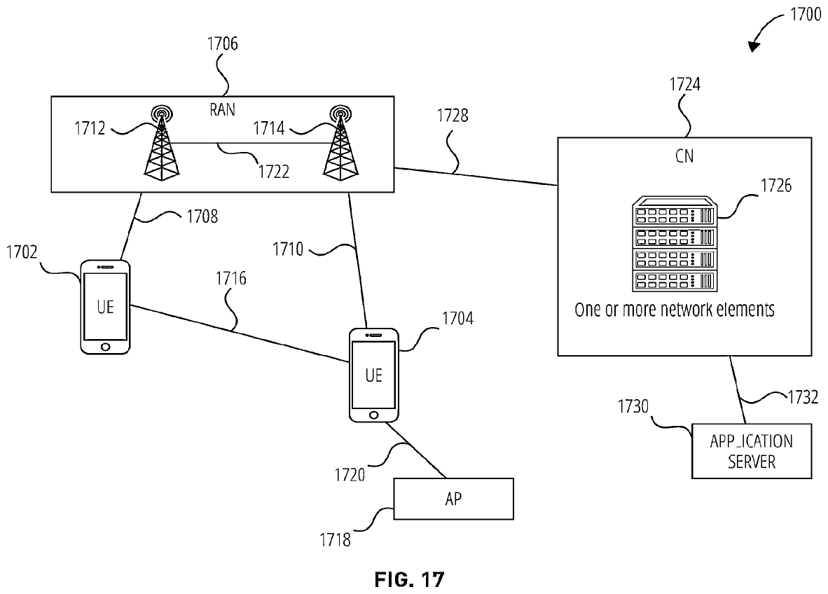

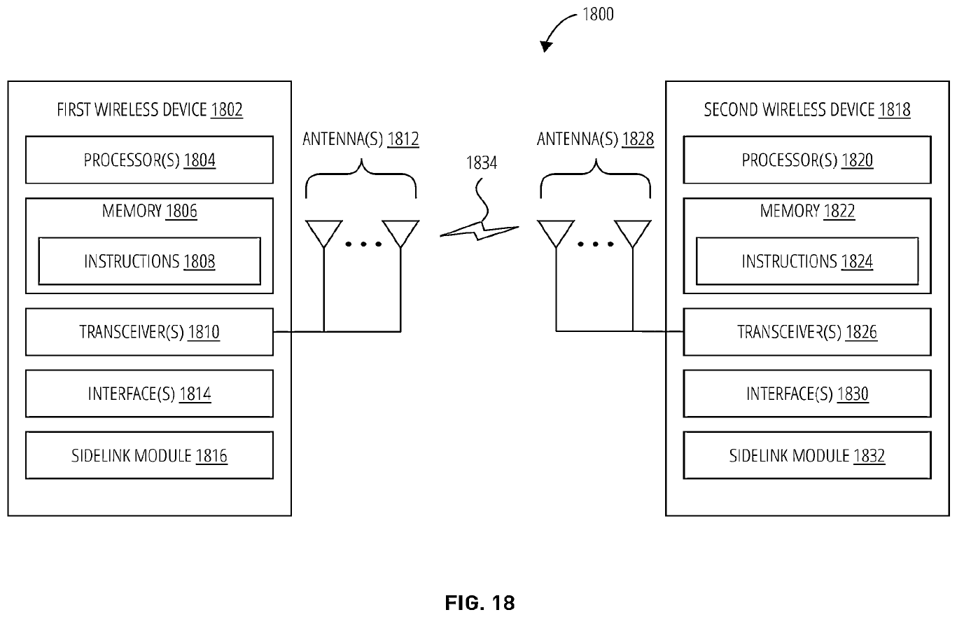

FIG. 17 illustrates an example architecture of a wireless communication system 1700, according to embodiments disclosed herein. The following description is provided for an example wireless communication system 1700 that operates in conjunction with the LTE system standards and/or 5G or NR system standards as provided by 3GPP technical specifications.

As shown by FIG. 17, the wireless communication system 1700 includes UE 1702 and UE 1704 (although any number of UEs may be used). In this example, the UE 1702 and the UE 1704 are illustrated as smartphones (e.g., handheld touchscreen mobile computing devices connectable to one or more cellular networks), but may also comprise any mobile or non-mobile computing device configured for wireless communication.

The UE 1702 and UE 1704 may be configured to communicatively couple with a RAN 1706. In embodiments, the RAN 1706 may be NG-RAN, E-UTRAN, etc. The UE 1702 and UE 1704 utilize connections (or channels) (shown as connection 1708 and connection 1710, respectively) with the RAN 1706, each of which comprises a physical communications interface. The RAN 1706 can include one or more base stations, such as base station 1712 and base station 1714, which enable the connection 1708 and connection 1710.

In this example, the connection 1708 and connection 1710 are air interfaces to enable such communicative coupling, and may be consistent with RAT(s) used by the RAN 1706, such as, for example, an LTE and/or NR.

In some embodiments, the UE 1702 and UE 1704 may also directly exchange communication data via a sidelink interface 1716. The UE 1704 is shown to be configured to access an access point (shown as AP 1718) via connection 1720. By way of example, the connection 1720 can comprise a local wireless connection, such as a connection consistent with any IEEE 802.11 protocol, wherein the AP 1718 may comprise a Wi-Fi© router. In this example, the AP 1718 may be connected to another network (for example, the Internet) without going through a CN 1724.

In embodiments, the UE 1702 and UE 1704 can be configured to communicate using orthogonal frequency division multiplexing (OFDM) communication signals with each other or with the base station 1712 and/or the base station 1714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1712 or base station 1714 may be implemented as one or more software entities running on server computers as part of a virtual network. In addition, or in other embodiments, the base station 1712 or base station 1714 may be configured to communicate with one another via interface 1722. In embodiments where the wireless communication system 1700 is an LTE system (e.g., when the CN 1724 is an EPC), the interface 1722 may be an X2 interface. The X2 interface may be defined between two or more base stations (e.g., two or more eNBs and the like) that connect to an EPC, and/or between two eNBs connecting to the EPC. In embodiments where the wireless communication system 1700 is an NR system (e.g., when CN 1724 is a 5GC), the interface 1722 may be an Xn interface. The Xn interface is defined between two or more base stations (e.g., two or more gNBs and the like) that connect to 5GC, between a base station 1712 (e.g., a gNB) connecting to 5GC and an eNB, and/or between two eNBs connecting to 5GC (e.g., CN 1724).

The RAN 1706 is shown to be communicatively coupled to the CN 1724. The CN 1724 may comprise one or more network elements 1726, which are configured to offer various data and telecommunications services to customers/subscribers (e.g., users of UE 1702 and UE 1704) who are connected to the CN 1724 via the RAN 1706. The components of the CN 1724 may be implemented in one physical device or separate physical devices including components to read and execute instructions from a machine-readable or computer-readable medium (e.g., a non-transitory machine-readable storage medium).

In embodiments, the CN 1724 may be an EPC, and the RAN 1706 may be connected with the CN 1724 via an S1 interface 1728. In embodiments, the S1 interface 1728 may be split into two parts, an S1 user plane (S1-U) interface, which carries traffic data between the base station 1712 or base station 1714 and a serving gateway (S-GW), and the S1-MME interface, which is a signaling interface between the base station 1712 or base station 1714 and mobility management entities (MMEs).

In embodiments, the CN 1724 may be a 5GC, and the RAN 1706 may be connected with the CN 1724 via an NG interface 1728. In embodiments, the NG interface 1728 may be split into two parts, an NG user plane (NG-U) interface, which carries traffic data between the base station 1712 or base station 1714 and a user plane function (UPF), and the S1 control plane (NG-C) interface, which is a signaling interface between the base station 1712 or base station 1714 and access and mobility management functions (AMFs).

Generally, an application server 1730 may be an element offering applications that use internet protocol (IP) bearer resources with the CN 1724 (e.g., packet switched data services). The application server 1730 can also be configured to support one or more communication services (e.g., VoIP sessions, group communication sessions, etc.) for the UE 1702 and UE 1704 via the CN 1724. The application server 1730 may communicate with the CN 1724 through an IP communications interface 1732.

FIG. 18 illustrates a system 1800 for performing signaling 1834 between a first wireless device 1802 and a second wireless device 1818, according to embodiments disclosed herein. The system 1800 may be a portion of a wireless communications system as herein described. The first wireless device 1802 may be, for example, a UE of a wireless communication system. The second wireless device 1818 may be, for example, a UE of the wireless communication system. It is also contemplated that in some cases, either of the first wireless device 1802 or the second wireless device 1818 may be a base station of the wireless communication system (e.g., that is using SL signaling methods described herein).

The first wireless device 1802 may include one or more processor(s) 1804. The processor(s) 1804 may execute instructions such that various operations of the first wireless device 1802 are performed, as described herein. The processor(s) 1804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The first wireless device 1802 may include a memory 1806. The memory 1806 may be a non-transitory computer-readable storage medium that stores instructions 1808 (which may include, for example, the instructions being executed by the processor(s) 1804). The instructions 1808 may also be referred to as program code or a computer program. The memory 1806 may also store data used by, and results computed by, the processor(s) 1804.

The first wireless device 1802 may include one or more transceiver(s) 1810 that may include radio frequency (RF) transmitter and/or receiver circuitry that use the antenna(s) 1812 of the first wireless device 1802 to facilitate signaling (e.g., the signaling 1834) to and/or from the first wireless device 1802 with other devices (e.g., the second wireless device 1818) according to corresponding RATs.

The first wireless device 1802 may include one or more antenna(s) 1812 (e.g., one, two, four, or more). For embodiments with multiple antenna(s) 1812, the first wireless device 1802 may leverage the spatial diversity of such multiple antenna(s) 1812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the first wireless device 1802 may be accomplished according to precoding (or digital beamforming) that is applied at the first wireless device 1802 that multiplexes the data streams across the antenna(s) 1812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the first wireless device 1802 may implement analog beamforming techniques, whereby phases of the signals sent by the antenna(s) 1812 are relatively adjusted such that the (joint) transmission of the antenna(s) 1812 can be directed (this is sometimes referred to as beam steering).

The first wireless device 1802 may include one or more interface(s) 1814. The interface(s) 1814 may be used to provide input to or output from the first wireless device 1802. For example, a first wireless device 1802 that is a UE may include interface(s) 1814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1810/antenna(s) 1812 already described) that allow for communication between the UE and other devices and may operate according to known protocols (e.g., Wi-Fi®, Bluetooth®, and the like).

The first wireless device 1802 may include a sidelink module 1816. The sidelink module 1816 may be implemented via hardware, software, or combinations thereof. For example, the sidelink module 1816 may be implemented as a processor, circuit, and/or instructions 1808 stored in the memory 1806 and executed by the processor(s) 1804. In some examples, the sidelink module 1816 may be integrated within the processor(s) 1804 and/or the transceiver(s) 1810. For example, the sidelink module 1816 may be implemented by a combination of software components (e.g., executed by a DSP or a general processor) and hardware components (e.g., logic gates and circuitry) within the processor(s) 1804 or the transceiver(s) 1810.

The sidelink module 1816 may be used for various aspects of the present disclosure, for example, aspects of FIG. 1 to FIG. 16. For example, the sidelink module 1816 may be configured to perform procedures for S-SSB frequency domain enhancement, procedures for S-SSB time domain enhancement, procedures for multi-beam S-SSB enhancement, procedures for S-SSB enhancement using frequency domain masking, and/or S-SSB enhancement using time domain masking, as discussed herein. The sidelink module 1816 may be configured to enact functionalities of one of a Tx UE and/or an Rx UE, as described herein.

The second wireless device 1818 may include one or more processor(s) 1820. The processor(s) 1820 may execute instructions such that various operations of the second wireless device 1818 are performed, as described herein. The processor(s) 1820 may include one or more baseband processors implemented using, for example, a CPU, a DSP, an ASIC, a controller, an FPGA device, another hardware device, a firmware device, or any combination thereof configured to perform the operations described herein.

The second wireless device 1818 may include a memory 1822. The memory 1822 may be a non-transitory computer-readable storage medium that stores instructions 1824 (which may include, for example, the instructions being executed by the processor(s) 1820). The instructions 1824 may also be referred to as program code or a computer program. The memory 1822 may also store data used by, and results computed by, the processor(s) 1820.

The second wireless device 1818 may include one or more transceiver(s) 1826 that may include RF transmitter and/or receiver circuitry that use the antenna(s) 1828 of the second wireless device 1818 to facilitate signaling (e.g., the signaling 1834) to and/or from the second wireless device 1818 with other devices (e.g., the first wireless device 1802) according to corresponding RATs.

The second wireless device 1818 may include one or more antenna(s) 1828 (e.g., one, two, four, or more). In embodiments having multiple antenna(s) 1828, the second wireless device 1818 may perform MIMO, digital beamforming, analog beamforming, beam steering, etc., as has been described.

The second wireless device 1818 may include one or more interface(s) 1830. The interface(s) 1830 may be used to provide input to or output from the second wireless device 1818. For example, a second wireless device 1818 that is a UE may include interface(s) 1830 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1826/antenna(s) 1828 already described) that allow for communication between the UE and other devices and may operate according to known protocols (e.g., Wi-Fi©, Bluetooth©, and the like).

The second wireless device 1818 may include a sidelink module 1832. The sidelink module 1832 may be implemented via hardware, software, or combinations thereof. For example, the sidelink module 1832 may be implemented as a processor, circuit, and/or instructions 1824 stored in the memory 1822 and executed by the processor(s) 1820. In some examples, the sidelink module 1832 may be integrated within the processor(s) 1820 and/or the transceiver(s) 1826. For example, the sidelink module 1832 may be implemented by a combination of software components (e.g., executed by a DSP or a general processor) and hardware components (e.g., logic gates and circuitry) within the processor(s) 1820 or the transceiver(s) 1826.

The sidelink module 1832 may be used for various aspects of the present disclosure, for example, aspects of FIG. 1 through FIG. 16. For example, the sidelink module 1832 may be configured to perform procedures for S-SSB frequency domain enhancement, procedures for S-SSB time domain enhancement, procedures for multi-beam S-SSB enhancement, procedures for S-SSB enhancement using frequency domain masking, and/or S-SSB enhancement using time domain masking, as discussed herein. The sidelink module 1832 may be configured to enact functionalities of one of a Tx UE and/or an Rx UE (e.g., opposite of the functionality currently enacted by the sidelink module 1816), as described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) for sidelink (SL) communications, comprising:
selecting a first SL synchronization signal block (S-SSB) frequency hopping pattern; and
transmitting a first plurality of S-SSBs to a first peer UE according to the first S-SSB frequency hopping pattern.

2. The method of claim 1, wherein synchronization signal identifiers (SSIDs) used by the first plurality of S-SSBs correspond to the first frequency hopping pattern.

3. The method of claim 1, further comprising:
selecting a second S-SSB frequency hopping pattern; and
transmitting a second plurality of S-SSBs to a second peer UE according to the second frequency hopping pattern.

4. The method of claim 3, wherein:
first synchronization signal identifiers (SSIDs) used by the first plurality of S-SSBs correspond to the first frequency hopping pattern; and
second SSIDs used by the second plurality of S-SSBs correspond to the second frequency hopping pattern.

5. A method of a user equipment (UE) for sidelink (SL) communications, comprising transmitting a plurality of SL synchronization signal blocks (S-SSBs) in a frequency domain that is greater than eleven physical resource blocks (PRBs).

6. The method of claim 5, wherein each of the plurality of S-SSBs comprise more than 11 PRBs.

7. The method of claim 5, wherein the plurality of S-SSBs comprises repeated S-SSBs in the frequency domain.

8. A method of a first user equipment (UE) for sidelink (SL) communications, comprising:
receiving, from a second UE, one or more indexes corresponding to a configured set of SL synchronization signal blocks (S-SSBs); and
receiving, from the second UE, one or more S-SSBs, each of the one or more S-SSBs indicating a corresponding index of the one or more indexes;
wherein each of the one or more S-SSBs is transmitted by the second UE according to a beamforming corresponding to the corresponding index.

9. The method of claim 8, wherein each of the one or more S-SSBs implicitly indicates the corresponding index based on a transmission timing.

10. The method of claim 8, wherein each of the one or more S-SSBs indicate the corresponding index in a physical sidelink broadcast channel (PSBCH) payload.

11. The method of claim 8, wherein:
each of the one or more S-SSBs indicates a first portion of the corresponding index in a physical sidelink broadcast channel (PSBCH) payload; and
each of the one or more S-SSBs indicates a second portion of the corresponding index using one of physical sidelink broadcast channel (PSBCH) scrambling, cyclic redundancy check (CRC) scrambling, and locations of PSBCH demodulation reference signals (DMRSs) within the one or more S-SSBs.

12. The method of claim 8, wherein each of the one or more S-SSBs indicates the corresponding indexes using sequences found in the one or more S-SSBs.

13. The method of claim 8, wherein each of the one or more S-SSBs transmits each of its symbols according to one or more of: a same Doppler spread; a same Doppler shift; a same average delay; a same delay spread; and a same spatial receive (Rx) parameters.

14. The method of claim 8, wherein each of the one or more S-SSBs is transmitted with a same power.

15. The method of claim 8, wherein a current S-SSB of the one or more S-SSBs indicating a same corresponding index as a prior S-SSB of the one or more S-SSBs is transmitted according to one or more of: a same Doppler spread used to transmit the prior S-SSB; a same Doppler shift used to transmit the prior S-SSB; a same average delay used to transmit the prior S-SSB; a same delay spread used to transmit the prior S-SSB; same spatial receive (Rx) parameters used to transmit the prior S-SSB; and a same power used to transmit the prior S-SSB.

16. The method of claim 8, wherein at least one of the one or more S-SSBs is configured to be used for one or more of: a first reference signal for quasi-colocation; a second reference signal for a path loss estimate; a third reference signal for radio link monitoring (RLM); a fourth reference signal for beam failure detection (BFD); and a fifth reference signal for candidate beam detection (CBD).

17-42. (canceled)
